(19) United States
(12) Patent Application Publication
(10) Pub. No.: US 2020/0274688 A1
(43) Pub. Date: Aug. 27, 2020

(54) METHOD AND APPARATUS FOR CONVERTING TRANSMITTING/RECEIVING FREQUENCY SIGNAL IN FDD COMMUNICATION

(71) Applicant: FCI INC., Seongnam-si (KR)

(72) Inventors: Jin Sang PARK, Seongnam-si (KR); Kyoo Hyun LIM, Seongnam-si (KR)

(21) Appl. No.: 16/520,379

(22) Filed: Jul. 24, 2019

(30) Foreign Application Priority Data
Feb. 26, 2019 (KR) 10-2019-0022369

(51) Int. Cl. H04L 5/14; H04B 1/44; H04B 7/155; H04B 1/00; H04B 1/401

(52) U.S. Cl. CPC H04L 5/1461; H04B 1/44; H04W 88/10; H04B 1/006; H04B 1/401; H04B 7/15557

(57) ABSTRACT

The disclosure relates to a method for converting a transmitting/receiving frequency which enables more effective conversion of a transmitting/receiving frequency according to a desired purpose in a communication apparatus using a full duplexing method wherein reception and transmission are performed simultaneously to make the communication apparatus commonly used at a base station and a terminal apparatus, and which enables fast and flexible constitution of the entire network of a communication network, and an apparatus for the method.

### FIELD OF INVENTION

The disclosure relates to a method for converting a transmitting/receiving frequency in frequency division duplexing (FDD) wireless communication, and an apparatus for the method, and more particularly, to an RF front end module apparatus which can be commonly used at a base station and a terminal apparatus in wireless mobile communication using an FDD wireless communication method.

### BACKGROUND OF INVENTION

The content described in this section merely provides background information for the disclosure, and does not constitute a conventional technology.

Recently, in wireless mobile communication, a method of dividing a receiving band frequency and a transmitting band frequency and enabling transmission at the same time as reception is mainly used, for using frequency resources effectively. To make this possible, a receiver should be able to receive a signal transmitted from the outside while suppressing a signal in the frequency band of a transmitter, so that the high output power of the transmitter is not introduced. In contrast, the transmitter should transmit a signal to the outside successfully, and prevent generation of signal leak to the receiver. A filter having such a function is called a duplexer, and it is an apparatus that enables simultaneous reception and transmission (full duplexing). As described above, a transmitting frequency and a receiving frequency of a base station become opposite to a transmitting frequency and a receiving frequency of a terminal apparatus, and as a receiving frequency and a transmitting frequency use specific fixed bands, they cannot be used interchangeably with each other.

Also, recently, as Internet of Things (IoT) wireless application such as long-term evolution (LTE) machine to machine (M2M) is extensively used, users are also expanding from general people to things. Following this, the number of base stations which can accommodate a lot of users is decreasing gradually. Thus, a concept of a small cell base station has been introduced, which enables a lot of users to be connected smoothly to a base station.

A small cell base station has small output power, as the literal meaning of the term, and thus it has no difference from general terminal apparatuses from the viewpoint of RF, and accordingly, the same hardware can be applied. Thus, in the future, a device to device (D2D) method will be used a lot, wherein, if a lot of LTE terminals are installed on objects, a base station does not connect all the objects, but if a base station is not spotted, a terminal and a terminal will function as a base station and a terminal apparatus for each other, and ultimately perform connection of communication to a base station.

To sum up, in a communication apparatus using a full duplexing method which performs reception and transmission simultaneously, a duplexer filter which was conventionally used at a base station and a terminal apparatus is manufactured into respective duplexer filters for a base station and a terminal apparatus, and they are manufactured with different boards from each other. However, because of the recent increase of small cell base stations wherein distinction between a base station and a terminal apparatus is decreasing gradually, and LTE IoT application which is to be applied to all kinds of objects, there are cases where transmitting/receiving frequency bands to a base station should be operated in an opposite way to application of the frequency bands to a terminal apparatus, without distinction between a base station and a terminal apparatus.

For addressing the aforementioned need, the disclosure suggests a configuration wherein an apparatus enabling the aforementioned function is constituted very simply with single components that have already been developed according to a desired purpose, which enables performing of such a function at a minimal cost.

### SUMMARY OF INVENTION

The disclosure is aimed at providing a method for converting a transmitting/receiving frequency which enables more effective conversion of a transmitting/receiving frequency according to a desired purpose in a communication apparatus using a full duplexing method wherein reception and transmission are performed simultaneously to make the communication apparatus commonly used at a base station and a terminal apparatus, and which enables fast and flexible constitution of the entire network of a communication network, and an apparatus for the method.

The disclosure provides an RF front end module apparatus including: a duplexer separating a transmitted signal and a received signal from a transmitting/receiving frequency signal of an antenna; a path change switch which has a plurality of inputs and outputs, and adaptively forms paths corresponding to the transmitted signal and the received signal by connecting each of the inputs and outputs in a cross direction or a forward direction according to a selected operation mode; a controller which selects the operation mode, and transmits a control signal for control of connection between the inputs and the outputs in response to the operation mode to the path change switch; a power amplifier which is positioned on the path of the transmitted signal; and a low noise amplifier which is positioned on the path of the received signal.

Also, according to another aspect of the disclosure, a method for converting a transmitting/receiving frequency signal of an RF front end module apparatus is provided, which includes the steps of: separating a transmitted signal and a received signal from a transmitting/receiving frequency signal of an antenna; selecting an operation mode of the RF front end module apparatus, and generating a control signal for control of connection between inputs and outputs of a path change switch in response to the selected operation mode; and adaptively forming paths corresponding to the transmitted signal and the received signal by connecting each of the plurality of inputs and outputs included in the path change switch in a cross direction or a forward direction based on the control signal.

According to the disclosure, there is an effect that, by making conversion of a transmitting/receiving frequency performed more effectively in a communication apparatus using a full duplexing method wherein reception and transmission are performed simultaneously, conversion of an operation from a base station to a terminal apparatus or from a terminal apparatus to a base station can be performed fast and in a convenient way, and through this, the entire network of a communication network can be constituted fast and flexibly.

Also, according to the disclosure, there is an effect that a terminal and a terminal function as a base station and a terminal apparatus for each other, and ultimately, a device to device (D2D) environment of performing connection of communication to a base station can be implemented more easily and at a cheaper cost.

### DESCRIPTION OF DRAWINGS

FIG. 1 is a block diagram illustrating a schematic configuration of an RF front end module apparatus according to an embodiment of the disclosure;

FIG. 2 is an exemplary diagram for illustrating an operation of a path change switch according to an embodiment of the disclosure;

FIG. 3A is an exemplary diagram for illustrating a method for converting a transmitting/receiving frequency signal according to the purpose of a communication apparatus according to an embodiment of the disclosure;

FIG. 3B is an exemplary diagram for illustrating a method for converting a transmitting/receiving frequency signal according to the purpose of a communication apparatus according to an embodiment of the disclosure;

FIG. 4A is an exemplary diagram for illustrating a method for converting a transmitting/receiving frequency signal according to the purpose of a communication apparatus according to an embodiment of the disclosure;

FIG. 4B is an exemplary diagram for illustrating a method for converting a transmitting/receiving frequency signal according to the purpose of a communication apparatus according to an embodiment of the disclosure;

FIG. 5 is a sequence diagram for illustrating a method for converting a transmitting/receiving frequency signal according to an embodiment of the disclosure; and

FIG. 6 is a diagram illustrating a communication environment to which the method for converting a transmitting/receiving frequency signal according to an embodiment of the disclosure is applied.

### DETAILED DESCRIPTION OF PREFERRED EMBODIMENTS

Hereinafter, some embodiments of the disclosure will be described in detail through exemplary drawings. Meanwhile, it should be noted that, in adding reference numerals to the components in each drawing, the same components will be indicated by the same reference numerals as far as possible, even though the components are displayed in different drawings. Also, in case it is determined that in describing the disclosure, detailed explanation of related known configurations or functions may unnecessarily confuse the gist of the disclosure, the detailed explanation will be omitted.

In addition, in describing the components of the disclosure, terms such as ‘the first,’ ‘the second,’ ‘A,’ ‘B,’ ‘(a),’ ‘(b),’ etc. may be used. These terms are only for distinguishing one component from another component, and are not intended to limit the essence, order, or sequence of the component. Also, throughout this specification, the description that a part ‘includes’ or ‘has’ a component is not intended to denote that other components are excluded, but that other components may be further included, unless there is any specific description meaning the contrary. In addition, the terms such as ‘ . . . unit,’ a part,′ etc. described in this specification mean units processing at least one function or operation, and they may be implemented as hardware or software, or a combination of hardware and software.

Because of the recent increase of small cell base stations wherein distinction between a base station and a terminal apparatus is decreasing gradually, and LTE IoT applications which is to be applied to all kinds of objects, there are cases where transmitting/receiving frequency bands to a base station should be operated in an opposite way to application of the frequency bands to a terminal apparatus, without distinction between a base station and a terminal apparatus.

For this, in the disclosure, contents regarding an RF front end module apparatus connected to an antenna in wireless mobile communication using an FDD (full duplexing) method wherein reception and transmission are performed simultaneously are described.

FIG. 1 is a block diagram illustrating a schematic configuration of an RF front end module apparatus according to an embodiment of the disclosure.

The RF front end module apparatus 100 according to an embodiment of the disclosure may be extensively applied to all FDD communication standards. For example, the RF front end module apparatus 100 may be applied to wireless mobile communication using a conventional FDD (full duplexing) method. Also, the RF front end module apparatus 100 may be applied to D2D communication wherein a terminal apparatus within a call area communicates with a terminal apparatus in a shadow area, and transmits information on the terminal apparatus in a shadow area to a base station, and the like.

As illustrated in FIG. 1, the RF front end module apparatus 100 according to an embodiment of the disclosure includes a duplexer 110, a path change switch 120, a controller 130, a power amplifier 140, and a low noise amplifier 150. Here, components included in the RF front end module apparatus 100 are not necessarily limited to the aforementioned components.

The duplexer 110 refers to an apparatus which separates a transmitted signal and a received signal from a transmitting/receiving frequency signal of an antenna.

In an embodiment of the disclosure, the duplexer 110 may separate a transmitted signal and a received signal by separating a transmitting/receiving frequency signal of an antenna into a first frequency band and a second frequency band according to a frequency division duplexing (FDD) method. Here, the first frequency band may be 392-394 MHz, and the second frequency band may be 382-384 MHz, but are not necessarily limited thereto. That is, the first frequency band and the second frequency band may be set as various frequency bands according to the communication environment and the communication standard to which the RF front end module apparatus 100 according to an embodiment of the disclosure is applied, etc. For example, in another embodiment of the disclosure, the first frequency band and the second frequency band may be set as a band of 824-849 MHz and a band of 860-894 MHz of LTE Band5.

Meanwhile, the duplexer 110 may be set such as the frequency band of a transmitted signal and the frequency band of a received signal may operate in an opposite way to each other, according to the purpose of a communication apparatus to which the RF front end module apparatus 100 is applied. For example, in case a communication apparatus operates as a base station supporting cellular communication with a terminal apparatus, the duplexer 110 may be implemented such that the first frequency band separates a transmitted signal (ex: a downlink signal), and the second frequency band separates a received signal (ex: an uplink signal). In contrast, in case a communication apparatus operates as a terminal apparatus supporting cellular communication with a base station, the duplexer 110 may be implemented such that the first frequency band separates a received signal (ex: a downlink signal), and the second frequency band separates a transmitted signal (ex: an uplink signal).

For this, the duplexer 110 may be constituted to include a first band passive filter that allows only a first frequency corresponding to a downlink signal to pass, and a second band passive filter that allows only a second frequency corresponding to an uplink signal to pass. In an embodiment of the disclosure, the duplexer 110 may be constituted in a structure wherein the first band passive filter is connected to a first output terminal of the path change switch 120, and the second band passive filter is connected to a second output terminal of the path change switch 120.

The path change switch 120 includes a plurality of inputs and outputs, and performs a function of adaptively forming paths corresponding to a transmitted signal and a received signal by adjusting connection between each of the inputs and the outputs. That is, in an embodiment of the disclosure, the path change switch 120 may adaptively form paths corresponding to a transmitted signal and a received signal by connecting each of the inputs and the outputs in a cross direction or a forward direction according to an operation mode selected from the controller 130. For this, the path change switch 120 may be implemented such that it receives an electronic signal (ex: a control signal) generated in response to the operation mode from the controller 130.

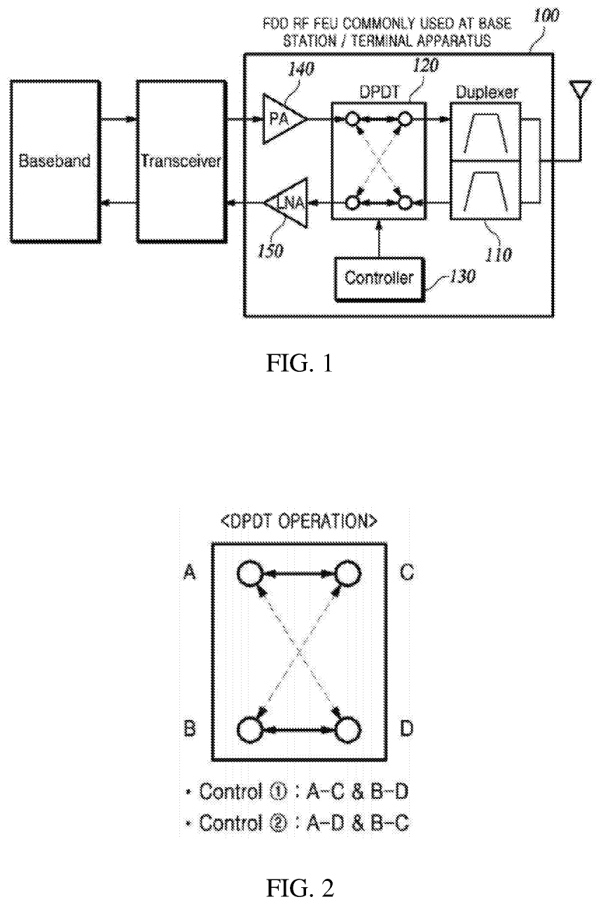

Hereinafter, descriptions will be made with reference to FIG. 2. In an embodiment according to the disclosure, the path change switch 120 may be implemented such that it includes two input terminals and two output terminals, and includes first to fourth switches for connecting each of the input terminals and the output terminals in a cross direction or a forward direction. Here, the first switch connects a first input terminal connected to the power amplifier 140 and a first output terminal connected to a downlink band filter of the duplexer 110. The second switch connects the first input terminal and a second output terminal connected to an uplink band filter of the duplexer 110. The third switch connects a second input terminal connected to the low noise amplifier 150 and the first output terminal. The fourth switch connects the second input terminal and the second output terminal.

The path change switch 120 may form paths corresponding to a transmitted signal and a received signal by connecting the first input terminal and the first output terminal according to a control signal (ex: control 1) from the controller 130, and connecting the second input terminal and the second output terminal. Also, the path change switch 120 may form paths corresponding to a transmitted signal and a received signal by connecting the first input terminal and the second output terminal according to a control signal (ex: control 2) from the controller 130, and connecting the second input terminal and the first output terminal.

In describing the operation of the path change switch 120 below, the operation will be described based on the assumption that the path change switch 120 includes two input terminals and two output terminals, but the disclosure is not necessarily limited thereto. For example, the path change switch 120 may be extended to N-pole N-through topology, and in this embodiment of the disclosure, the number of the input terminals and the output terminals of the path change switch 120 is not limited to a specific number.

Meanwhile, a detailed method for the path change switch 120 to adaptively form paths corresponding to a transmitted signal and a received signal by adjusting connection between each of the inputs and the outputs according to an operation mode selected from the controller 130 will be described later in the process of describing the operation of the controller 130.

The controller 130 performs the function of selecting an operation mode of the RF front end module apparatus 100, and transmitting a control signal for control of connection between the inputs and the outputs of the path change switch 120 in response to the selected operation mode to the path change switch 120.

In this embodiment of the disclosure, the controller 130 may identify the purpose of a communication apparatus wherein the RF front end module apparatus 100 is implemented based on information on a user's selection and a transmitting/receiving frequency signal, and according to the result of identification, select the operation mode of the RF front end module apparatus 100 as one of a base station mode, a terminal apparatus mode, a relaying terminal apparatus mode, and a relay subject terminal apparatus mode. Here, a base station mode refers to a mode corresponding to a case wherein the communication apparatus performs a function as a base station supporting cellular communication with a terminal apparatus. A terminal apparatus mode refers to a mode corresponding to a case wherein the communication apparatus performs a function as a terminal apparatus supporting cellular communication with a base station. A relaying terminal apparatus mode refers to a mode corresponding to a case wherein the communication apparatus supports a relaying function between a base station and a terminal apparatus in a shadow area in direct communication (ex: D2D) between terminal apparatuses. A relay subject terminal apparatus mode refers to a mode corresponding to a case wherein the communication apparatus receives support of the relaying function from the relaying terminal apparatus.

Hereinafter, a method for converting a transmitting/receiving frequency signal of the path change switch 120 according to an operation mode selected from the controller 130 will be described.

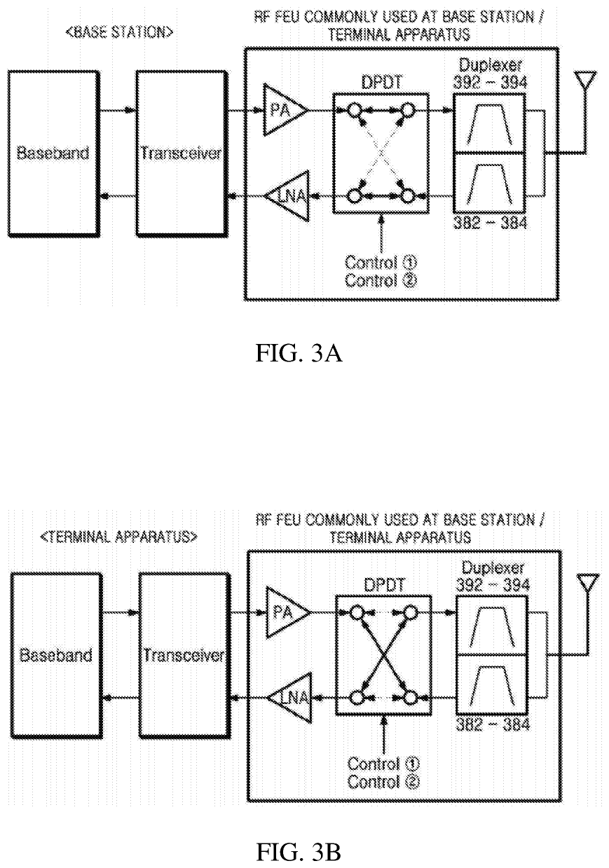

FIGS. 3A and 3B are diagrams illustrating an example of a method for converting a transmitting/receiving frequency signal in case the operation mode of the path change switch 120 is selected as a base station mode and a terminal apparatus mode respectively, by the controller 130.

First, referring to FIG. 3A, in case the operation mode of the path change switch 120 is selected as a base station mode by the controller 130, the path change switch 120 may form a path of a transmitted signal (=signal path 1: 392-394 MHz) leading to the downlink band filter of the duplexer 110 from the power amplifier 140 and a path of a received signal (=signal path 2: 382-384 MHz) leading to the low noise amplifier 150 from the uplink band filter of the duplexer 110 by connecting each of the inputs and the outputs in a forward direction.

Also, referring to FIG. 3B, in case the operation mode of the path change switch 120 is selected as a terminal apparatus mode by the controller 130, the path change switch 120 may form a path of a transmitted signal (=signal path 2: 382-384 MHz) leading to the uplink band filter of the duplexer 110 from the power amplifier 140 and a path of a received signal (=signal path 1: 392-394 MHz) leading to the low noise amplifier 150 from the downlink band filter of the duplexer 110 by connecting each of the inputs and the outputs in a cross direction.

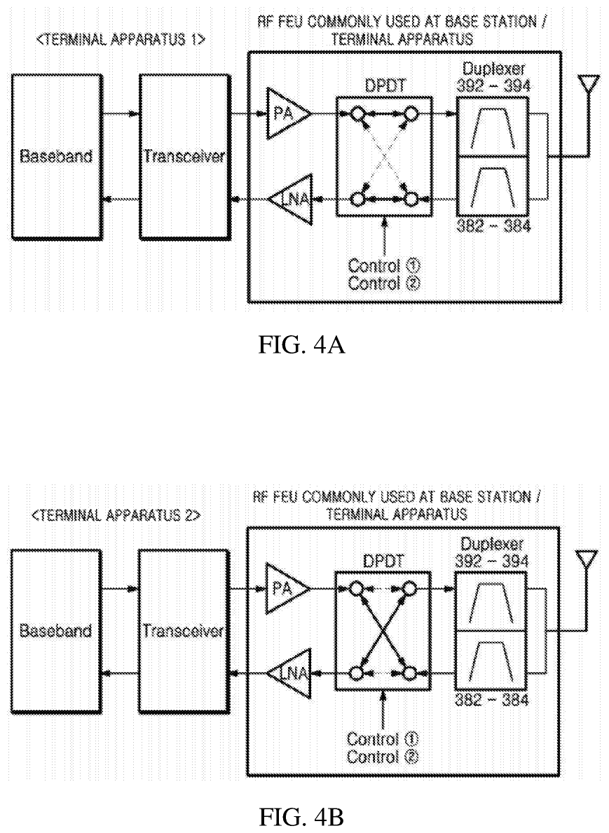

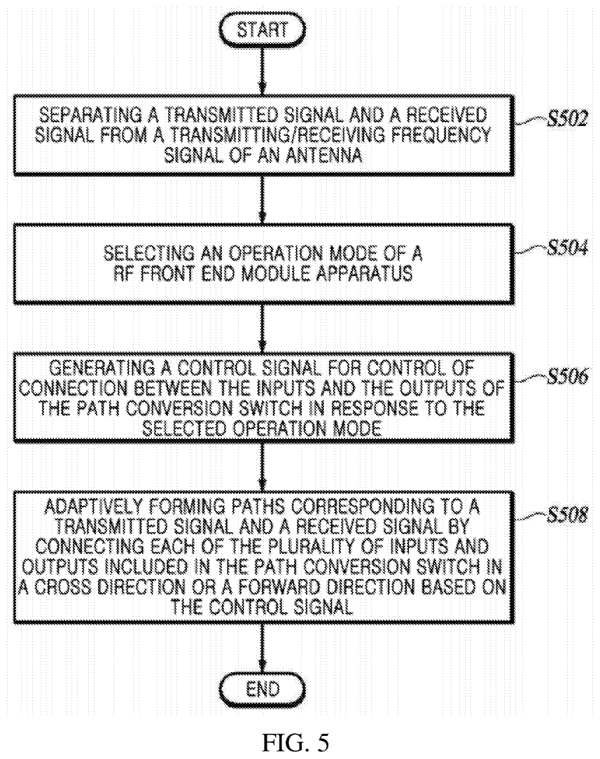

FIGS. 4A and 4B are diagrams illustrating an example of a method for converting a transmitting/receiving frequency signal in case the operation mode of the path change switch 120 is selected as a relaying terminal apparatus mode and a relay subject terminal apparatus mode respectively, by the controller 130.

First, referring to FIG. 4A, in case the operation mode of the path change switch 120 is selected as a relaying terminal apparatus mode by the controller 130, the path change switch 120 may form a path of a transmitted signal (=signal path 1: 392-394 MHz) leading to the downlink band filter of the duplexer 110 from the power amplifier 140 and a path of a received signal (=signal path 2: 382-384 MHz) leading to the low noise amplifier 150 from the uplink band filter of the duplexer 110 by connecting each of the inputs and the outputs in a forward direction.

Also, referring to FIG. 4B, in case the operation mode of the path change switch 120 is selected as a relay subject terminal apparatus mode by the controller 130, the path change switch 120 may form a path of a transmitted signal (=signal path 2: 382-384 MHz) leading to the uplink band filter of the duplexer 110 from the power amplifier 140 and a path of a received signal (=signal path 1: 392-394 MHz) leading to the low noise amplifier 150 from the downlink band filter of the duplexer 110 by connecting each of the inputs and the outputs in a cross direction.

The power amplifier 140 is positioned on the path of the transmitted signal of the RF front end module apparatus 100, and performs the function of amplifying a transmitted signal transmitted through the path, and outputs the signal.

The low noise amplifier 150 is positioned on the path of the received signal of the RF front end module apparatus 100, and performs the function of amplifying a received signal transmitted through the path, and outputs the signal.

As amplification of signals by the power amplifier 140 and the low noise amplifier 150 is a general technology in the pertinent technical field, a detailed description in that regard will be omitted.

Meanwhile, referring to FIGS. 3A to 4B, it can be figured out that in the case of this embodiment, the power amplifier 140 and the low noise amplifier 150 are respectively designed such that they are capable of amplifying all the transmitted signals or received signals of a base station and a terminal apparatus regardless of the operation mode of the RF front end module apparatus 100, and thus have a wideband characteristic.

FIG. 5 is a sequence diagram for illustrating a method for converting a transmitting/receiving frequency signal according to an embodiment of the disclosure.

The RF front end module apparatus 100 separates a transmitted signal and a received signal from a transmitting/receiving frequency signal of an antenna at operation 5502. At operation 5502, the RF front end module apparatus 100 includes the duplexer 110, and may separate a transmitted signal and a received signal by separating a transmitting/receiving frequency signal of an antenna into a first frequency band and a second frequency band through the duplexer 110 according to a frequency division duplexing (FDD) method.

Then, the RF front end module apparatus 100 selects an operation mode of the RF front end module apparatus 100 based on information on a user's selection and a transmitting/receiving frequency signal at operation 5504. At operation 5504, the RF front end module apparatus 100 may identify the purpose of a communication apparatus wherein the RF front end module apparatus 100 is implemented based on information on a user's selection and a transmitting/receiving frequency signal, and according to the result of identification, select the operation mode of the RF front end module apparatus 100 as one of a base station mode, a terminal apparatus mode, a relaying terminal apparatus mode, and a relay subject terminal apparatus mode.

In addition, the RF front end module apparatus 100 generates a control signal for control of connection between inputs and outputs of the path change switch 120 in the RF front end module apparatus 100 in response to the operation mode selected at operation 5504 at operation 5506.

Further, the RF front end module apparatus 100 adaptively forms paths corresponding to the transmitted signal and the received signal by connecting each of a plurality of inputs and outputs included in the path change switch 120 in a cross direction or a forward direction based on the control signal at operation 5506.

Here, operations 5502 to 5508 correspond to the operations of each component of the RF front end module apparatus 100 described above. Accordingly, a further detailed description will be omitted.

FIG. 5 describes that each process is executed sequentially, but the disclosure is not necessarily limited thereto. In other words, a method of executing the processes described in FIG. 5 by changing the processes, or a method of executing one or more processes in parallel may be applied. Thus, FIG. 5 does not limit the processes in a time series order.

As described above, the method for converting a transmitting/receiving frequency signal of the RF front end module apparatus 100 described in FIG. 5 may be implemented as a program, and may be recorded in a recording medium readable by using software of a computer (ex: a CD-ROM, RAM, ROM, a memory card, a hard disk, an optical magnetic disk, a storage device, etc.).

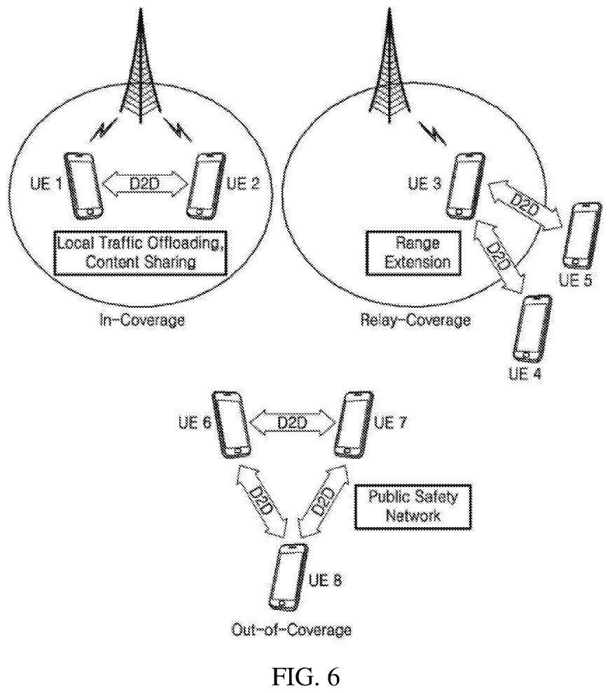

FIG. 6 is a diagram illustrating a communication environment to which the method for converting a transmitting/receiving frequency signal according to an embodiment of the disclosure is applied.

Referring to FIG. 6, the RF front end module apparatus 100 and the method for converting a transmitting/receiving frequency signal thereof according to an embodiment of the disclosure have an effect that they can be commonly used at a base station and a terminal apparatus in LTE Small Cell, D2D, M2M, and Relay communication methods.

That is, in the case of using the RF front end module apparatus according to an embodiment of the disclosure, conversion of a transmitting/receiving frequency can be performed more effectively according to the purpose of a communication apparatus wherein the RF front end module apparatus 100 is implemented. For example, in the disclosure, a terminal apparatus is made to operate while being converted to a base station connecting several terminals, and to a general terminal apparatus again fast and in a convenient way, and thus there is an effect that the entire network of a communication network can be constituted effectively, fast and flexibly.

The descriptions above are merely exemplary embodiments of the technical idea of the disclosure, and it is apparent that various amendments and modifications can be made by those having ordinary skill in the technical field to which the disclosure belongs, without departing from the gist of the disclosure. Accordingly, the embodiments described above are not for limiting the technical idea of the disclosure, but for describing it, and the scope of the technical idea of the disclosure is not to be limited by the embodiments. In addition, the scope of protection of the disclosure is to be interpreted by the appended claims, and all technical ideas within the same scope are to be interpreted to be included in the scope of protection of the disclosure.

What is claimed is:

1. An RF front end module apparatus comprising:
a duplexer separating a transmitted signal and a received signal from a transmitting/receiving frequency signal of an antenna;
a path change switch which has a plurality of inputs and outputs, and adaptively forms paths corresponding to the transmitted signal and the received signal by connecting each of the inputs and outputs in a cross direction or a forward direction according to a selected operation mode;
a controller which selects the operation mode, and transmits a control signal for control of connection between the inputs and the outputs in response to the operation mode to the path change switch;
a power amplifier which is positioned on the path of the transmitted signal; and
a low noise amplifier which is positioned on the path of the received signal.

2. The RF front end module apparatus of claim 1,
wherein the duplexer separates the transmitted signal and the received signal according to a frequency division duplexing (FDD) method.

3. The RF front end module apparatus of claim 1,
wherein the path change switch includes two input terminals and two output terminals, and comprises:
a first switch which connects a first input terminal connected to the power amplifier and a first output terminal connected to a downlink band filter of the duplexer;
a second switch which connects the first input terminal and a second output terminal connected to an uplink band filter of the duplexer;
a third switch which connects a second input terminal connected to the low noise amplifier and the first output terminal; and
a fourth switch which connects the second input terminal and the second output terminal.

4. The RF front end module apparatus of claim 1,
wherein the controller selects, based on information on a user's selection and the transmitting/receiving frequency signal, any one of a base station mode supporting cellular communication with a terminal apparatus, a terminal apparatus mode supporting cellular communication with a base station, a relaying terminal apparatus mode supporting a relaying function between a base station and a terminal apparatus in direct communication between terminal apparatuses, and a relay subject terminal apparatus mode receiving support of the relaying function from the relaying terminal apparatus as the operation mode.

5. The RF front end module apparatus of claim 4,
wherein the path change switch is configured to, based on the operation mode selected as the base station mode by the controller, connect each of the inputs and the outputs in a forward direction according to the control signal, and form the path of the transmitted signal which leads to the downlink band filter of the duplexer from the power amplifier and the path of the received signal which leads to the low noise amplifier from the uplink band filter of the duplexer.

6. The RF front end module apparatus of claim 4,
wherein the path change switch is configured to, based on the operation mode selected as the terminal apparatus mode by the controller, connect each of the inputs and the outputs in a cross direction according to the control signal, and form the path of the transmitted signal which leads to the uplink band filter of the duplexer from the power amplifier and the path of the received signal which leads to the low noise amplifier from the downlink band filter of the duplexer.

7. The RF front end module apparatus of claim 4,
wherein the path change switch is configured to, based on the operation mode selected as the relaying terminal apparatus mode by the controller, connect each of the inputs and the outputs in a forward direction according to the control signal, and form the path of the transmitted signal which leads to the downlink band filter of the duplexer from the power amplifier and the path of the received signal which leads to the low noise amplifier from the uplink band filter of the duplexer.

8. The RF front end module apparatus of claim 4,
wherein the path change switch is configured to, based on the operation mode selected as the relay subject terminal apparatus mode by the controller, connect each of the inputs and the outputs in a cross direction according to the control signal, and form the path of the transmitted signal which leads to the uplink band filter of the duplexer from the power amplifier and the path of the received signal which leads to the low noise amplifier from the downlink band filter of the duplexer.

9. A method for converting a transmitting/receiving frequency signal of an RF front end module apparatus comprising:
separating a transmitted signal and a received signal from a transmitting/receiving frequency signal of an antenna;
selecting an operation mode of the RF front end module apparatus, and generating a control signal for control of connection between inputs and outputs of a path change switch in response to the selected operation mode; and
adaptively forming paths corresponding to the transmitted signal and the received signal by connecting each of the plurality of inputs and outputs included in the path change switch in a cross direction or a forward direction based on the control signal.
